(19) United States
(12) Patent Application Publication
(10) Pub. No.: US 2011/0137778 A1
(43) Pub. Date: Jun. 9, 2011

(54) INFORMATION PROCESSING APPARATUS CAPABLE OF REALIZING PROPER BILLING PROCESSING, METHOD OF CONTROLLING THE INFORMATION PROCESSING APPARATUS, AND STORAGE MEDIUM

(75) Inventor: Shukei Kurihara, Yokohama-shi (JP)

(73) Assignee: CANON KABUSHIKI KAISHA, Tokyo (JP)

(21) Appl. No.: 12/956,433

(22) Filed: Nov. 30, 2010

(30) Foreign Application Priority Data
Dec. 3, 2009 (JP) 2009-275448

(51) Int. Cl. G06Q 30/00; G06F 15/16

(52) U.S. Cl. 705/34; 709/204

(57) ABSTRACT

An information processing apparatus which make it possible to achieve correct billing processing free from an error in the amount of processed pages and prevent users from using a service without being billed. A cloud is connected via a network to a printer that receives data and performs image processing thereon. A processing server performs predetermined processing on data received via the network. A directory server transmits processed data formed by the predetermined processing to the printer. A billing server performs billing for the predetermined processing, after a completion notification indicative of completion of the image processing is received from the printer. The director server determines whether the received data requires the completion notification. When the received data requires the completion notification, the directory server transmits processed data of a next page after receiving the completion notification on processed data of a preceding page.

### BACKGROUND OF THE INVENTION

1. Field of the Invention

The present invention relates to an information processing apparatus, such as a server apparatus, which is connected to a network, and a method of controlling the information processing apparatus, and a non-transitory computer-readable storage medium storing a computer-executable program causing a computer to execute the method.

2. Description of the Related Art

Recently, there has come into widespread use a technique called cloud computing in which software is made use of not by executing application software programs by user's own computer, but by receiving services provided on the Internet. More specifically, in this technique, application software programs and the like which are used by computers are not installed at a computer at hand, but are installed in a system called a cloud on the Internet and users access them to make use thereof on an as-needed basis. The technique of cloud computing has a characterizing feature that users can enjoy provided services without being aware of the entity of a could formed by a plurality of servers.

Under the environment of cloud computing, users only pay for as much as the amount of using the cloud, which is advantageous in that initial investment required for installing a server, purchasing application software programs, etc. can be reduced.

Recently, it is envisaged to apply such an environment of cloud computing to a printing environment. In this case, while printing devices support only fundamental functions, additional functions are caused to be performed by the cloud on the network. This makes it possible to construct a printing environment which reduces the costs of the main unit of each printing device and at the same time provides services of adding values by high-end functions thereof.

As described above, under the environment of cloud computing, users desires to be billed according to processing executed by the cloud (charge on an as-used basis). However, if a use is billed only for processing by the cloud without actual printing due to an error during printing, this is a disadvantage to the user. Therefore, it is necessary for the cloud to perform a billing process after completion of printing by the printing device.

In view of this, conventionally, there has been proposed a method of billing services provided by a Web server in Japanese Patent Laid-Open Publication No. 2001-350864. According to the proposed technique, in a system comprising a Web server provided by a data supplier, computers of data users, and printers connected to the computers of the data users, there is employed the following method: A data user receives image data to use from a Web server, and after completion of printing of image data on a job unit basis, the data user notifies the completion of the printing to the Web server in a form of billing data, whereafter the Web server executes billing processing.

However, the method of executing the billing processing after printing completion notification is sent to a server (cloud) upon completion of printing on a job unit basis has the following problem: The Internet is under an incessant changes of network traffic, and hence it is expected that when a network is down, the printing completion notification does not reach the cloud, which can result in an inconvenience that the user uses the printing service without being billed for the service he received.

### SUMMARY OF THE INVENTION

The present invention provides an information processing apparatus, a method of controlling the information processing apparatus, and a non-transitory computer-readable storage medium storing a computer-executable program for causing a computer to execute the method, which make it possible to achieve correct billing processing which is free from an error in the amount of pages on which image processing, such as printing, has been performed by an image processing apparatus of a data user, and at the same prevent the user from using services without being billed.

In a first aspect of the present invention, there is provided an information processing apparatus that can be connected to an image processing apparatus which receives data via a network and performs image processing on the data, comprising a processing unit configured to perform predetermined processing on data received via the network, a transmission unit configured to transmit processed data which is formed by the predetermined processing of the processing unit, to the image processing apparatus, a billing unit configured to perform a billing process for billing for the predetermined processing, after a completion notification indicative of completion of the image processing on the processed data transmitted by the transmission unit is received from the image processing apparatus, and a determination unit configured to determine whether or not the received data is data requiring the completion notification of the image processing, wherein when the received data is data requiring the completion notification of the image processing, the transmission unit performs transmission of processed data of a next page after receiving a completion notification of the image processing on processed data of a preceding page which precedes the next page from the image processing apparatus.

In a second aspect of the present invention, there is provided a method of controlling an information processing apparatus that can be connected to an image processing apparatus which receives data via a network and performs image processing on the data, comprising performing predetermined processing on data received via the network, transmitting processed data which is formed by the predetermined processing, to the image processing apparatus, performing a billing process for billing for the predetermined processing, after a completion notification indicative of completion of the image processing on the processed data transmitted by the transmitting is received from the image processing apparatus, and determining whether or not the received data is data requiring the completion notification of the image processing, wherein when the received data is data requiring the completion notification of the image processing, the transmitting includes transmitting processed data of a next page after receiving a completion notification of the image processing on processed data of a preceding page which precedes the next page from the image processing apparatus.

In a third aspect of the present invention, there is provided a non-transitory computer-readable storage mediums storing a computer-executable program for causing a computer to execute a method of controlling an information processing apparatus that can be connected to an image processing apparatus which receives data via a network and performs image processing on the data, wherein the method comprises performing predetermined processing on data received via the network, transmitting processed data which is formed by the predetermined processing, to the image processing apparatus, performing a billing process for billing for the predetermined processing, after a completion notification indicative of completion of the image processing on the processed data transmitted by the transmitting is received from the image processing apparatus, and determining whether or not the received data is data requiring the completion notification of the image processing, wherein when the received data is data requiring the completion notification of the image processing, the transmitting includes transmitting processed data of a next page after receiving a completion notification of the image processing on processed data of a preceding page which precedes the next page from the image processing apparatus.

According to the present invention, it is possible to achieve correct billing processing which is free from an error in the amount of pages on which image processing, such as printing, has been performed by the image processing apparatus of a data user, and at the same prevent users from using a service without being billed.

The features and advantages of the invention will become more apparent from the following detailed description taken in conjunction with the accompanying drawings.

### BRIEF DESCRIPTION OF THE DRAWINGS

FIG. 1 is a block diagram of a whole printing system including an information processing apparatus according to a first embodiment of the present invention.

FIGS. 2A and 2B are block diagrams of details of a cloud-side configuration of the printing system.

FIGS. 3A and 3B are diagrams of an example of a user's environment-side configuration of the printing system.

FIG. 4 is a block diagram of an example of a software configuration of a user's environment side of the printing system.

FIG. 5 is a flowchart of a process executed by a host computer of the printing system.

FIG. 6 is a flowchart of a process executed by a printer of the printing system.

FIGS. 7A and 7B are a flowchart of a process executed by a cloud.

FIG. 8 is a flowchart of a process of copy-forgery-inhibited pattern processing requiring printing completion notification.

FIG. 9 is a flowchart of a process of copy-forgery-inhibited pattern processing not requiring printing completion notification.

FIGS. 10A and 10B are a flowchart of a billing process executed by a billing server.

FIG. 11 is a block diagram of a whole printing system including an information processing apparatus according to a second embodiment of the present invention.

FIG. 12 is a flowchart of a process executed by a host computer of the printing system.

FIG. 13 is a flowchart of a process executed by a printer of the printing system.

FIG. 14 is a block diagram of a whole printing system including an information processing apparatus according to a third embodiment of the present invention.

FIG. 15 is a flowchart of a process executed by a host computer of the printing system.

FIG. 16 is a flowchart of a process executed by a printer of the printing system.

### DETAILED DESCRIPTION OF THE EMBODIMENTS

The present invention will now be described in detail below with reference to the accompanying drawings showing embodiments thereof.

Now, a description will be given of an example of a printing system which makes use of a cloud, and includes an information processing apparatus according to an embodiment of the present invention.

In a printing system making use of a cloud, the use of the cloud enables printers to realize functions which are not supported by the printers. For example, if a printer does not support the function of copy-forgery-inhibited pattern processing, but the cloud offers a service of copy-forgery-inhibited pattern processing, print job data is sent to the cloud, and after subjecting the data to copy-forgery-inhibited pattern processing, the processed data is sent back to the printer. Then, the printer executes printing of the processed data.

As for billing for services in the printing system that makes use of a cloud, there can be envisaged various methods. One envisaged method is that the cloud bills for the number of pages which are processed by the cloud, and the printer bills for actually executed printout. The billing by the printer is performed for the number of sheets which are actually printed as conventionally performed.

However, even if the cloud bills for its service of processing print job data, there can occur failure of printing of the processed data or the like. Therefore, if the billing by the cloud is executed immediately after completion of processing of the print job data, there can arise a problem of overbilling for provided services e.g. when printing is not actually executed. Therefore, it is necessary to perform billing processing after receiving a printing completion notification from the printer. However, in the case of a job in which data processed by the cloud is stored in a storage area of a printer, when transmission of the data to the printer has been completed, it can be judged that the data is stored in the storage area, and hence it is possible to perform billing processing without a printing completion notification.

The description of the present embodiment is given by taking an example in which the cloud is caused to perform copy-forgery-inhibited pattern processing (an example of predetermined processing) on print data, and a printer prints out the processed print data. A job which requires actual printing (hereinafter referred to as “printing job”) necessitates a printing completion notification. On the other hand, a job for only storing data processed by the cloud in a storage area, such as a hard disk drive (HDD), of a printer without printing the same (hereinafter referred to as “store-in-HDD job”) does not necessitate a printing completion notification.

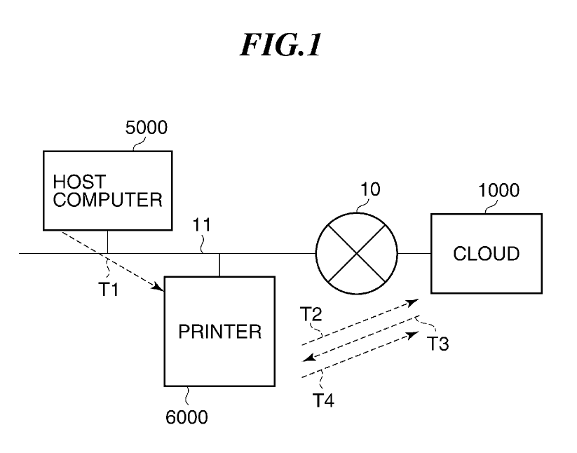

FIG. 1 is a block diagram of a whole printing system including an information processing apparatus according to a first embodiment of the present invention.

As shown in FIG. 1, a host computer 5000 and a printer 6000 (an example of an image processing apparatus) in a user's environment are connected by a LAN (Local Area Network) 11. The LAN 11 is connected to a cloud 1000 (an example of an information processing apparatus) comprising a plurality of servers, via the Internet 10. That is, the user's environment including the host computer 5000 and the printer 6000, and the cloud 1000 are connected to each other via the Internet 10, thereby constituting a printing system including the information processing apparatus according to the present embodiment.

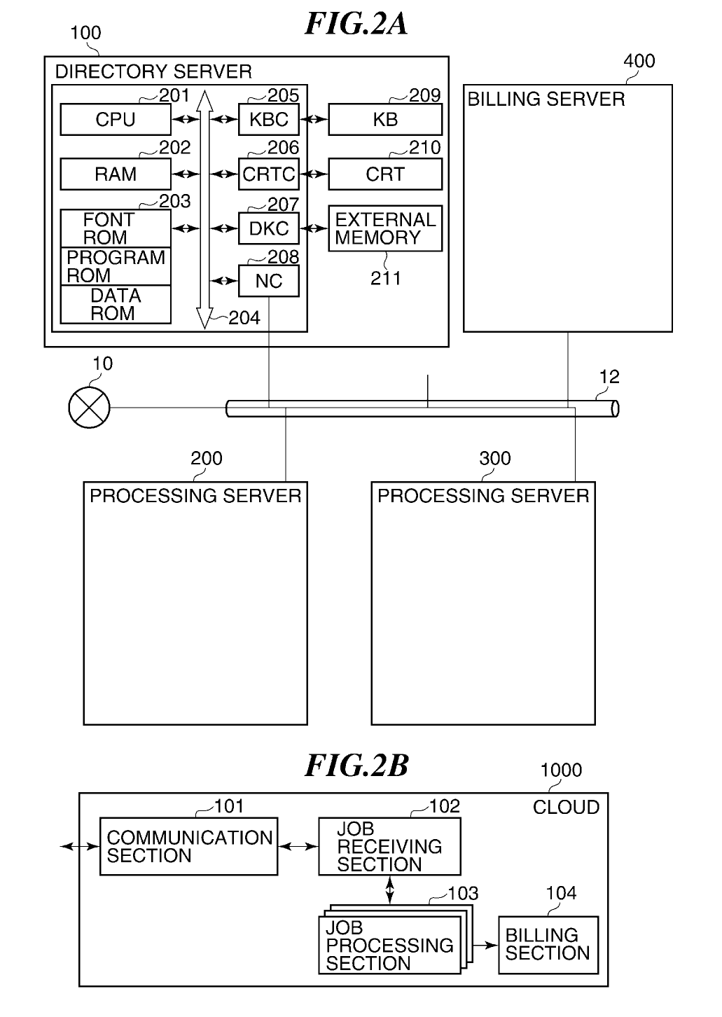

FIGS. 2A and 2B are block diagrams of details of a cloud-side configuration of the printing system. FIG. 2A shows an example of a hardware configuration, while FIG. 2B shows a software configuration.

The hardware of the cloud 1000 in the present embodiment comprises, as shown in FIG. 2A, a directory server 100 (an example of a transmission unit), processing servers 200 and 300 (an example of a processing unit), and a billing server 400 (an example of a billing unit). These components are connected via a network 12. The number of processing servers increases according to the number of functions provided by the cloud 1000. The directory server 100 has a function of receiving job data from the host computer 5000, and the processing servers 200 and 300 have a function of performing processing based on settings designated by a job. The billing server 400 has a function of performing billing processing according to the processing executed by the processing servers 200 and 300.

The directory server 100 includes a CPU (Central Processing Unit) 201 that assigns items of received job data to respective selected ones of the processing servers based on a job receiving program or the like stored in a program ROM within a ROM (Read Only Memory) 203 or an external memory 211. The CPU 201 performs centralized control of devices connected to a system bus 204.

Further, the program ROM in the ROM 203 or the external memory 211 stores an operating system program which is a control program for the CPU 201, etc. A data ROM in the ROM 203 or the external memory 211 also stores various kinds of data for use in performing job assigning processing and the like. A RAM (Random Access Memory) 202 functions as a main memory, a work area, etc. for the CPU 201.

Connected to the system bus 204 are a keyboard controller (KBC) 205, a CRT controller (CRTC) 206, a disk controller (DKC) 207, and a network controller (NC) 208.

The keyboard controller 205 controls a key input from a keyboard 209 and an input from a pointing device, not shown. The CRT controller 206 controls display of a CRT display 210. The disk controller 207 controls access to the external memory 211, such as the hard disk drive, which stores a boot program, various application programs, user files, edit files, etc. The network controller 208 is connected to the processing servers 200 and 300 and the billing server 400 via the network, for executing processing for control of communication with the processing servers 200 and 300 and the billing server 400.

The hardware configuration of the processing servers 200 and 300 and the billing server 400 is substantially the same as that of the directory server 100, but is different only in that the program ROM of the ROM 203 or the external memory 211 of each of the processing servers 200 and 300 stores processing programs. Further, in the billing server 400, a billing processing program is stored in the program ROM of the ROM 203 or the external memory 211 thereof.

As shown in FIG. 2B, the cloud 1000 includes, as software modules, a communication section 101, a job receiving section 102, job processing sections 103, and a billing section 104. The communication section 101 receives data from the printer 6000 and transmits data from the cloud 1000.

Upon receipt of job data from the communication section 101, the job receiving section 102 analyzes received data to determine requested processing, and transmits the job data to a corresponding one of the job processing sections 103. Further, upon receipt of an output completion notification (an example of completion notification of the image processing) of the printer from the communication section 101, the job receiving section 102 forwards the output completion notification to the job processing section 103. The job processing section 103 performs processing on the received job data to form print data, and sends the print data to the communication section 101. Upon receipt of the output completion notification from the job receiving section 102, the job processing section 103 notifies completion of the processing by the job processing section 102 to the billing section 104. Upon receipt of the notification of completion of the processing from the job processing section 103, the billing section 104 executes billing processing.

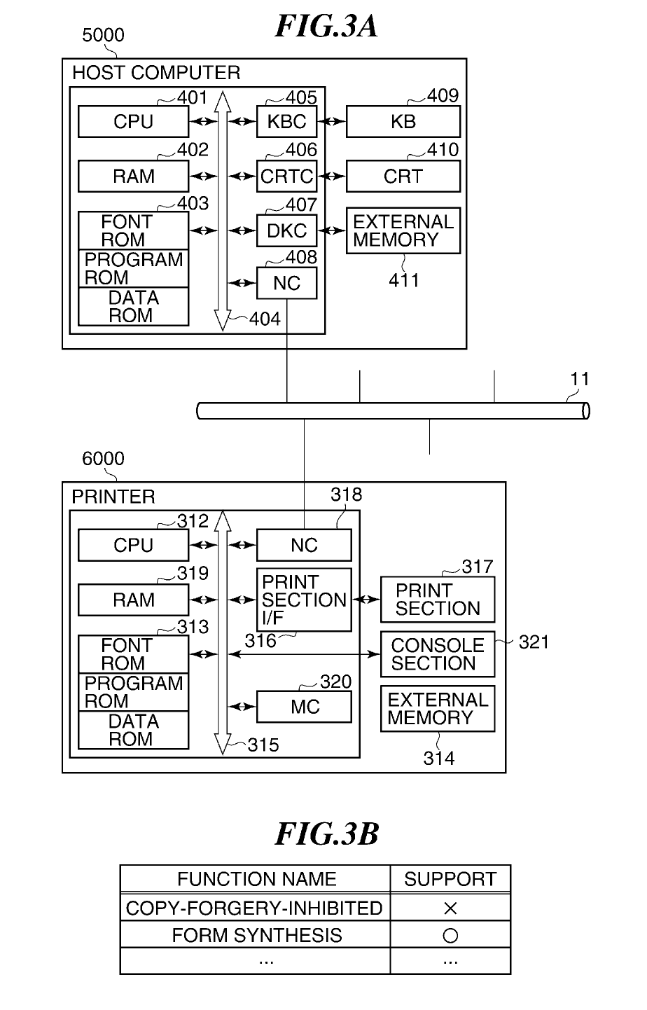

FIGS. 3A and 3B are diagrams of an example of a user's environment-side configuration of the printing system. FIG. 3A shows a hardware configuration of a user's environment side of the printing system, and FIG. 3B shows an example of a specification table used in the present embodiment.

The host computer 5000 stores application programs, a printer control command-generating program, and so forth, in a program ROM in a ROM 403 or an external memory 411 shown in FIGS. 3A and 3B. The host computer 5000 includes a CPU 401 that executes, based on the programs, processing for generating document data containing figures, images, characters, tables (including spreadsheets) and processing for generating print job data of document data. The CPU 401 performs centralized control of devices connected to a system bus 404.

Further, the program ROM in the ROM 403 or the external memory 411 stores an operating system program which is a control program for the CPU 401, etc. A font ROM in the ROM 403 or the external memory 411 also stores font data and the like for use in performing the processing for generating print job data of document data. Further, a data ROM in the ROM 403 or the external memory 411 also stores various kinds of data for use in performing the processing for generating document data, the processing for generating print job data, etc. A RAM 402 functions as a main memory, a work area, etc. for the CPU 401.

Connected to the system bus 404 are a keyboard controller 405, a CRT controller 406, a disk controller 407, and a network controller 408.

The keyboard controller 405 controls a key input from a keyboard 409 and an input from a pointing device, not shown. The CRT controller 406 controls display of a CRT display 410. The disk controller 207 controls access to the external memory 411, such as the hard disk drive, which stores a boot program, various application programs, a printer control command-generating program (hereinafter referred to as “the printer driver”), etc. The network controller 408 is connected to the printer 6000 and the cloud 1000 via the network, and executes processing for control of communication with the printer 6000 and the cloud 1000.

The CPU 401 opens various kinds of windows registered in advance, based on commands indicated by a mouse cursor, not shown, on the CRT display 410, and executes various kinds of data processing. Before executing printing, the user can open a window for print settings to perform configuration of the printer 6000.

The printer 6000 is controlled by a CPU 312. The CPU 312 operates based on a control program and the like stored in a program ROM of a ROM 313 and an external memory 314 to output an image signal as output information to a print section (printer engine) 317 connected via a print section interface (I/F) 316 to a system bus 315. Further, the program ROM in the ROM 313 stores the control program for the CPU 312, and so forth. A font ROM in the ROM 313 stores font data and the like for use in generating the output information. A data ROM in the ROM 313 stores information and the like used by the host computer 5000 when the printer 6000 is not equipped with the external memory 314, such as the hard disk drive. The external memory 314 can store print data of the user. Also connected to the system bus 315 is a console section 321 which displays an output from the CPU 312 on an liquid crystal display (not shown) thereof, and accepts an input from the user and transmits the input to the CPU 312.

The data ROM in the ROM 313 or the external memory 314 stores a specification table as shown in FIG. 3B. This table is used for confirming whether settings (e.g. copy-forgery-inhibited pattern processing) of print job data received from the host computer 5000 are for functions supported by the printer 6000. This will be described in detail hereinafter.

The CPU 312 is capable of performing communication with the host computer 5000 and the cloud 1000 via a network interface (I/F) 318. Information and the like within the printer 6000 can be notified to the host computer 5000 and the cloud 1000. A RAM 319 functions as a main memory, a work area, and so forth, for the CPU 312.

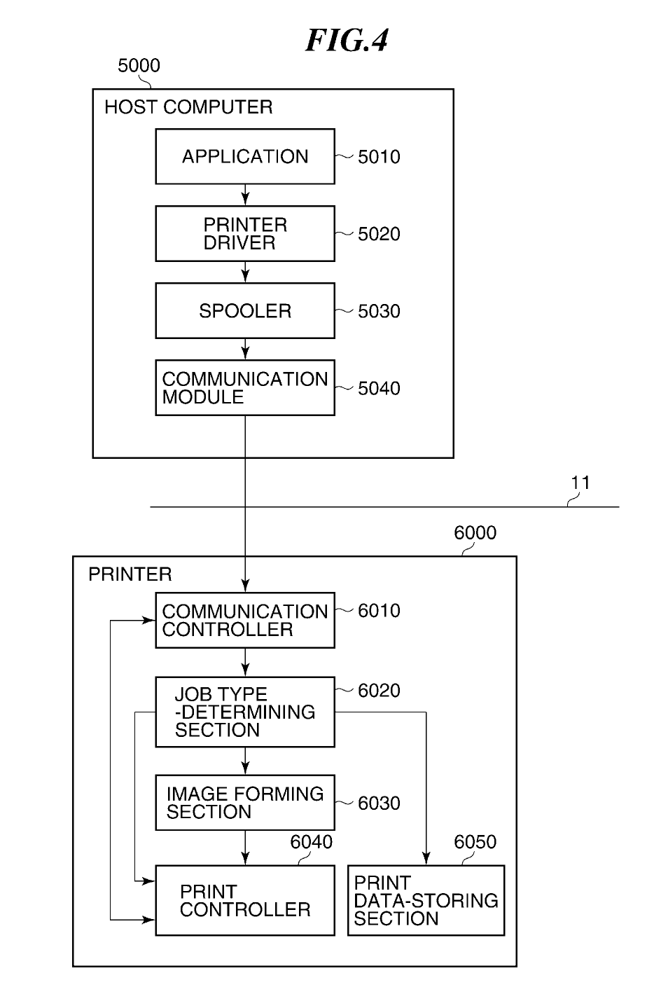

FIG. 4 is a block diagram of an example of a software configuration of the user's environment side of the printing system.

Image data requested to be printed via an application 5010 is passed to a printer driver 5020, and the printer driver 5020 generates print job data. The generated print job data is spooled in a spooler 5030. The spooled print job data is passed to a communication module 5040. The communication module 5040 transmits the received print job data to the printer 6000 via the LAN 11.

A communication controller 6010 of the printer 6000 receives print job data, and passes the print job data to a job type-determining section 6020. The job type-determining section 6020 determines whether or not the print job data can be processed by the printer 6000 by itself. If it is determined that the print job data cannot be processed by the printer 6000 by itself, the communication controller 6010 transmits the print job data to the cloud 1000.

On the other hand, if the job type-determining section 6020 determines that the print job data can be processed by the printer 6000 by itself, it passes the print job data to an image forming section 6030. The image forming section 6030 generates print data from the print job data, and passes the print data to a print controller 6040 for execution of printing processing.

Further, when the printer 6000 receives print data (an example of processed data) from the cloud 1000 via the communication controller 6010, the job type-determining section 6020 determines whether or not the print data requires printing. If the print data is data of a job requiring printing (i.e. data of a printing job), the job type-determining section 6020 passes the print data to the print controller 6040 for execution of printing processing. When printing of each page has been completed, printing completion is notified to the cloud 1000 on a page-by-page basis. On the other hand, if the job type-determining section determines that the print data is data of a job not requiring printing (i.e. store-in-HDD job), it passes the print data to a print data-storing section 6050 to store the print data in a storage area of the printer 6000.

Next, an outline of processing executed by the printing system configured as described above will be described with reference to FIG. 1.

The print job data generated by the host computer 5000 is transmitted to the printer 6000 (T1 in FIG. 1). The printer 6000 determines whether or not the received print job data can be processed by itself. Then, if the printer 6000 determines that the received print job data cannot be processed by itself, it transmits the print job data to the cloud 1000 (T2). More specifically, when the received print job data requires copy-forgery-inhibited pattern processing, the printer 6000 determines whether the printer 6000 is capable of copy-forgery-inhibited pattern processing, and if not capable, the printer 6000 transmits the print job data to the cloud 1000.

Then, the cloud 1000 performs copy-forgery-inhibited pattern processing on the received print job data to generate print data, and sends the print data to the printer 6000 (T3). The printer 6000 executes either printing of the received print data or storing of the print data in the storage area in the case of the job being a store-in-HDD job, and then transmits an output completion notification to the cloud 1000 (T4).

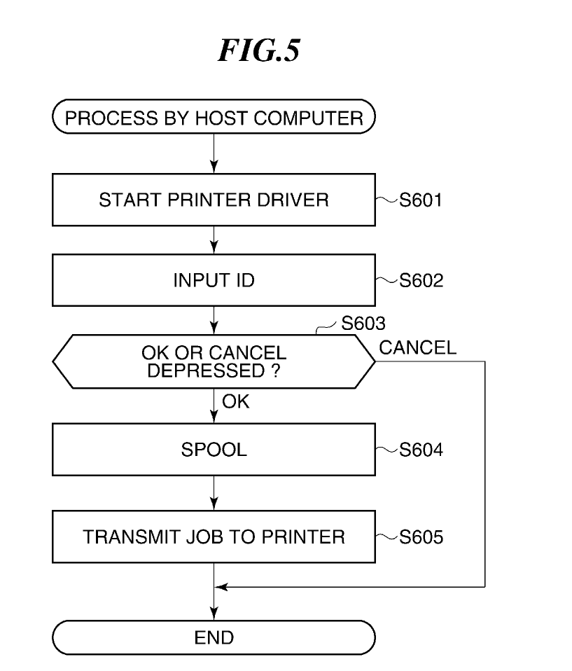

Next, processing by the host computer 5000 and the printer 6000 on the user's environment side will be described with reference to FIG. 5.

FIG. 5 is a flowchart of a process executed by the host computer 5000 of the printing system.

This process is executed by the CPU 401 executing a program stored e.g. in the ROM 403.

First, in a step S601, the application 5010 selected via a print button, not shown, by the user starts the printer driver 5020. In the next step S602, the printer driver 5020 displays an ID input screen, not shown. Via the screen, the printer driver 5020 receives a user ID and a company ID input by the user.

Then, in a step S603, the printer driver 5020 determines whether or not an OK button, or a cancel button, neither of which is shown, has been depressed on the ID input screen. If the OK button is depressed, the process proceeds to a step S604, whereas if the cancel button is depressed, the present process is immediately terminated.

In the step S604, the printer driver 5020 generates print job data, and spools the print job data in the spooler 5030. The print job data includes a user ID, a company ID, a job type (print job, store-in-HDD job or the like), and a job setting (e.g. copy-forgery-inhibited pattern processing), as job information.

Then, in a step S605 following the step S604, the communication module 5040 receives the print job data from the spooler 5030, and then transmits the print job data to the printer 6000.

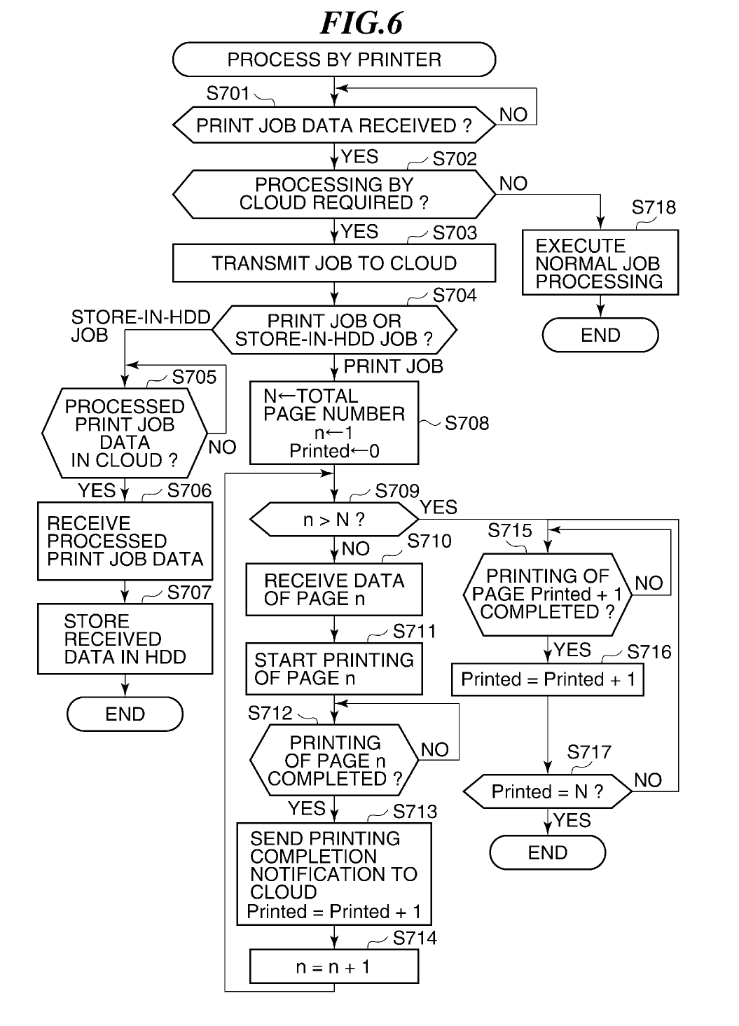

FIG. 6 is a flowchart of a process executed by the printer 6000. This process is executed by the CPU 312 executing a program stored e.g. in the ROM 313.

First, in a step S701, it is determined whether or not print job data is received from the host computer 5000. If the print job data is received, the process proceeds to a step S702, whereas if not, the process returns to the step S701. In the step S702, it is determined whether or not the print job data requires processing by the cloud 1000.

This determination is executed by checking whether a processing (e.g. copy-forgery-inhibited pattern processing) set for print job data can be executed by the functions supported by the printer 6000, against the specification table (see FIG. 3B). If the processing set for the print job data can be executed by the functions supported by the printer 6000, it is determined that it is not required to use the cloud 1000, i.e. the answer to the question of the step S702 is negative (NO), and the process proceeds to a step S718, wherein normal job processing is executed, followed by terminating the present process.

On the other hand, if the processing set for the print job data requires a function not supported by the printer 6000, the process proceeds to a step S703, wherein the print job data is transmitted to the cloud 1000. Then, in a step S704, it is determined whether or not the received print job data is data of a print job or data of a store-in-HDD job. If the print job data is data of a store-in-HDD job, the process proceeds to a step S705, whereas if the print job data is data of a print job, the process proceeds to a step S708.

In the step S705, the printer 6000 queries the cloud 1000 whether there is processed print job data. If there is processed print job data, the process proceeds to a step S706, whereas if not, the step S705 is executed again. In the step S706, the printer 6000 requests the cloud 1000 to send the processed print job data and receives the same, and in the next step S707, the processed print job data received in the step S706 is stored in the storage area of the printer 6000, followed by terminating the present process.

If it is determined in the step S704 that the print job data received by the printer 6000 is data of a print job, in the step S708, a work area for print processing is initialized. Here, a total page number “N” is initialized to a total page number of job information, a page number “n” of a page being processed is initialized to 1, and a printing-completed page count “Printed” is initialized to 0.

In the next step S709, it is determined whether or not the page number “n” of the page being processed is larger than the total page number “N”, i.e. whether or not there is processed data of the present job in the cloud 1000. If “n” is not larger than “N”, it is judged that there is processed data in the cloud 1000, so that the process proceeds to a step S710, whereas if “n” is larger than “N”, the process proceeds to a step S715.

In the step S710, the printer 6000 requests the cloud 1000 to send print job data of page “n”, and receives the print job data. Then in a step S711, printing of page “n” is started, and the process proceeds to a step S712, wherein it is determined whether or not printing of page “n” has been completed. If the printing of page “n” has been completed, the process proceeds to a step S713, whereas if not, the process returns to the step S712.

In the step S713, the printer 6000 sends a printing completion notification to the cloud 1000, and increments “Printed” by 1. Further, in a step S714, the printer 6000 increments “n” by 1, and the process returns to the step S709.

In the step S715, it is determined whether or not printing of page “Printed+1” has been completed. If the printing has been completed, the process proceeds to a step S716, whereas if not, the process returns to the step S715. In the step S716, “Printed” is incremented by 1.

In the next step S717, it is determined whether or not “Printed” is equal to “N”, i.e. whether or not all the pages have been printed. If “Printed” is equal to “N”, it is determined that all the pages have been printed, and the present process is terminated, whereas if not, the process returns to the step S715.

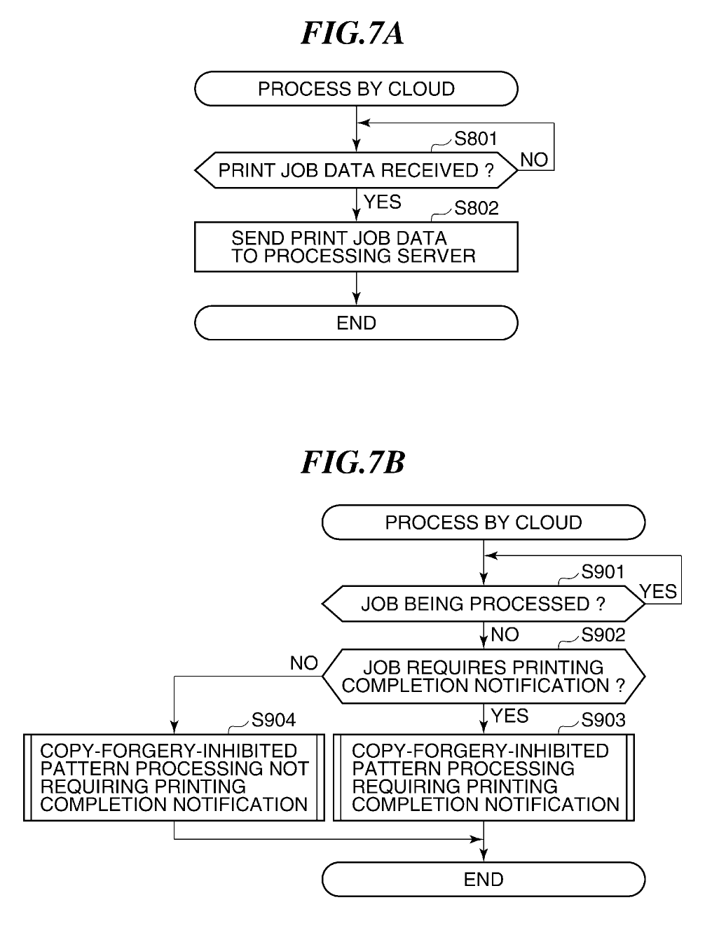

Next, a process executed by the cloud 1000 will be described with reference to FIGS. 7A, 7B, 8, and 9.

FIG. 7A is a flowchart of the process executed by the directory server 100 of the cloud 1000. This process is executed by the CPU 201 executing a program stored e.g. in the ROM 203.

First, in a step S801, it is determined whether or not print job data is received from the printer 6000. If it is determined that print job data is received, the process proceeds to a step S802, whereas if not, the process returns to the step S801.

In the step S802, the directory server 100 determines a job type of the received print job data from job information thereof, and assigns a cloud job ID to the print job data to send the same to a processing server associated with the job type. In the present embodiment, the directory server 100 sends the print job data to one of the processing servers 200 and 300, which performs copy-forgery-inhibited pattern processing. The directory server 100 returns the cloud job ID to the printer 6000.

FIG. 7B is a flowchart of a process executed by the processing server which performs copy-forgery-inhibited pattern processing. This process is executed by the CPU 201 of the processing server 200 or 300 executing a program stored e.g. in the ROM 203 of the same.

First, in a step S901, it is determined whether or not the job is being processed. If the job is not being processed, the process proceeds to a step S902, wherein it is determined whether or not the print job data requires printing completion notification. In the present embodiment, if the job is a print job, it is determined that the print job data requires printing completion notification, and the process proceeds to a step S903, and if the job is a store-in-HDD job, determining that the print job data does not require printing completion notification, the process proceeds to a step S904.

In the step S903, copy-forgery-inhibited pattern processing requiring printing completion notification is executed, whereas in the step S904, copy-forgery-inhibited pattern processing not requiring printing completion notification is executed, followed by terminating the present process.

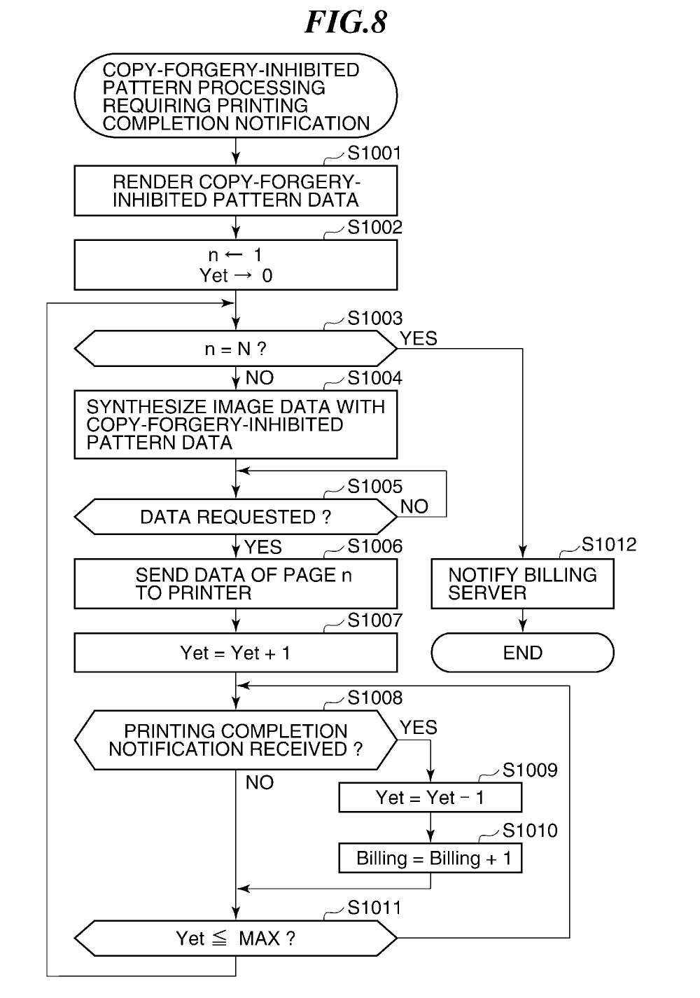

FIG. 8 is a flowchart of a process of the copy-forgery-inhibited pattern processing requiring printing completion notification, i.e. details of the step S904 in FIG. 7B.

As a preparation, a work area is initialized in advance. More specifically, the total page number “N” is initialized to the total page number of the job information, the count “Billing” of a billing page counter that counts the number of pages which are processed and are to be billed is initialized to 0, and an unfinished page upper limit value “Max” is initialized to e.g. 20. “Max” may be set by device information on a job-by-job basis. If “Max” is 0, after printing of the preceding page is completed, processing of the following page is permitted to be executed. Beside these, “n” indicative of the page number of a page being processed and “Yet” indicative of the number of unfinished pages are prepared in the work area.

In a step S1001, rendering of copy-forgery-inhibited pattern data is executed, and then in a step S1002, “n” is initialized to 1 and “Yet” is initialized to 0.

In the next step S1003, it is determined whether or not “n” is equal to “N”, i.e. whether or not processing of all pages has been completed. If “n” is equal to “N”, it is determined that the processing has been completed, and the process proceeds to a step S1012, whereas if not, the process proceeds to a step S1004. In the step S1004, the image data of page “n” is rendered and synthesized with copy-forgery-inhibited pattern data. In a step S1005, it is determined whether or not sending of a page has been requested by the printer 6000. If the sending of a page has been requested, the process proceeds to a step S1006, whereas if not, the process returns to the step S1005.

In the step S1006, the processed data of page “n” is transmitted as print data to the printer 6000, and in the following step S1007, “Yet” is incremented by 1. Then, in a step S1008, it is determined whether or not printing completion notification has been received from the printer 6000. If printing completion notification has been received, the process proceeds to a step S1009, whereas if not, the process proceeds to a step S1011. In the step S1009, “Yet” is decremented by 1, and in the following step S1010, “Billing” is incremented by 1.

In the step S1011, it is determined whether or not “Yet” is not larger than “Max”. If printing completion notification is awaited on a page-by-page basis, the performance is degraded, and hence insofar as the number of pages of which printing completion notification has not been received is within a predetermined number, the process proceeds to processing of a next page. If “Yet” is not larger than “Max”, the process returns to the step S1003, whereas if not, the process returns to the step S1008. In the step S1012, a user ID, a company ID, and “Billing” are notified to the billing server 400 as billing information, followed by terminating the present process.

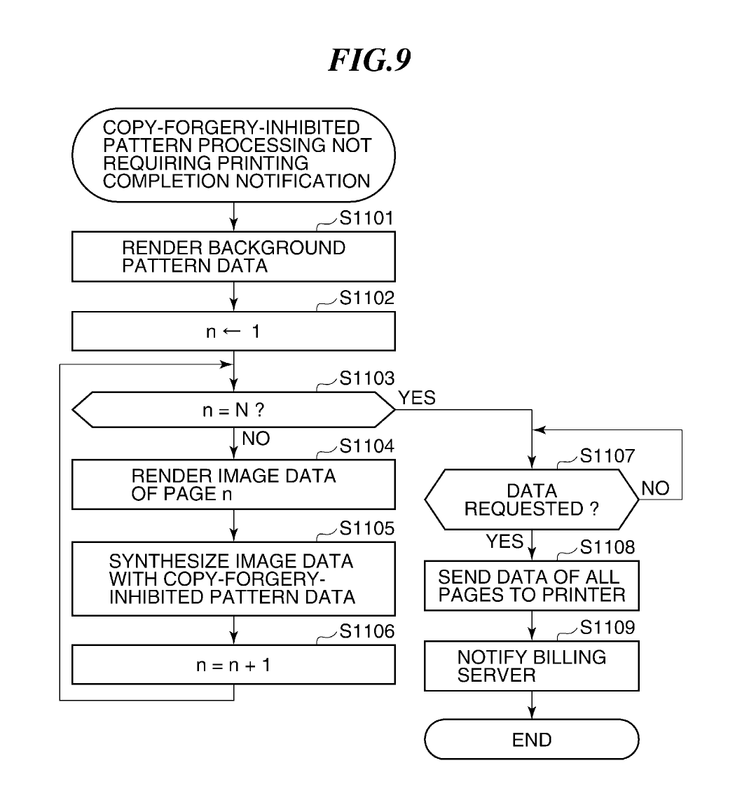

FIG. 9 is a flowchart of a process of the copy-forgery-inhibited pattern processing not requiring printing completion notification, i.e. details of the step S903 in FIG. 7B.

First, as a preparation, the work area is initialized in advance. Here, the total page number “N” is initialized to the total page number of the job information. In a step S1101, copy-forgery-inhibited pattern data is rendered, and in the next step S1102, the page number “n” of the page being processed is initialized to 1.

In the following step S1103, it is determined whether or not processing of all the pages has been completed. If “n” is equal to “N”, it is determined that the processing has been completed, and the process proceed to a step S1107, whereas if not, the process proceeds to a step S1104, wherein the rendering of page “n” is executed.

In a step S1105 following the step S1104, the image data of page “n” and the copy-forgery-inhibited pattern data are synthesized with each other. In a step S1106, “n” is incremented by 1, the process returns to the step S1103. In the step S1107, it is determined whether or not a request of sending the data is received from the printer 6000. If the request is received, the process proceeds to a step S1108, whereas if not, the process returns to the step S1107. In the step S1108, the processed data of all the pages is transmitted as print data to the printer 6000 having made the request. Then, in a step S1109, the user ID, the company ID, and “N” are notified to the billing server 400, followed by terminating the present process.

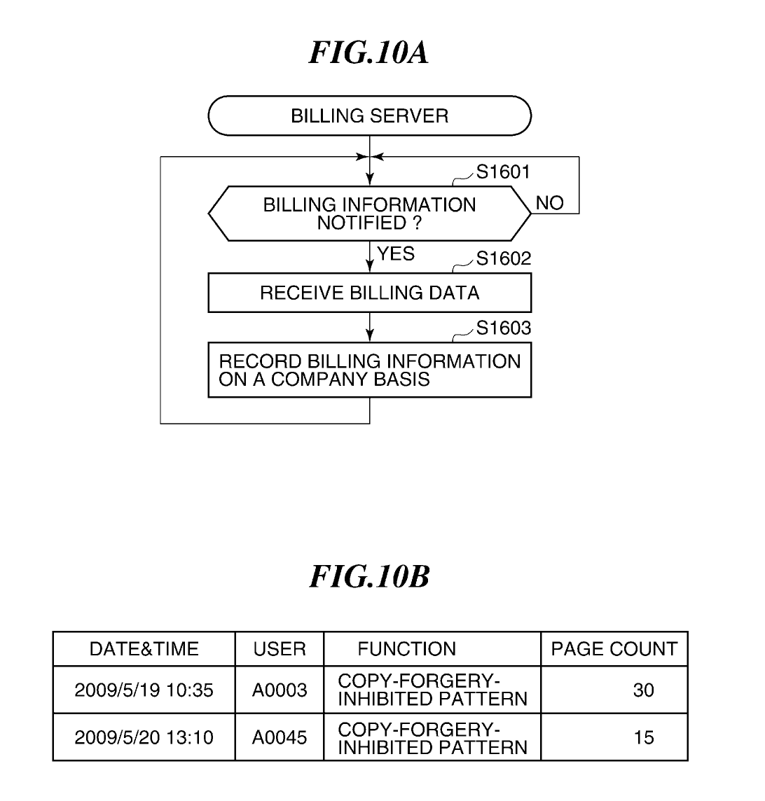

FIG. 10A is a flowchart of a billing process executed by the billing server 400.

This process is executed by the CPU 201 of the billing server 400 executing a program stored in the ROM 203 of the same.

In a step S1601, it is determined whether or not billing information has been received from the processing server 200 or 300. If billing information has been received, the process proceeds to a step S1602, wherein billing data is received. Then, the process proceeds to a step S1603, wherein the billing information is recorded e.g. on a company ID-by-company ID basis as shown in FIG. 10B (one example of billing).

According to the first embodiment described above, in the cloud computing environment, the cloud 100 performs billing in response to receipt of a printing completion notification transmitted from the printer 6000 of the user who uses the data, and executes processing of the following page. More specifically, if job data requires a printing completion notification, after the printing completion notification of a preceding page is received from the printer 6000 (step S1008), billing of the page is executed (step S1010), and then processing of the following page is executed. This makes it possible to perform accurate billing in which the number of billed pages is not different from the number of printed pages, and thereby makes it possible to minimize cases where users receive services without being billed.

Further, as to the same job data, insofar as the number of pages for which no printing completion notification has been received is within a predetermined number (step S1011), processing of a next page is performed even if a printing completion notification has not been received from the printer 6000. This makes it possible to continue the processing even if the printing completion notification has not been received for the predetermined number of pates, and hence it is possible to avoid degradation of the performance.

Next, a second embodiment of the present invention will be described.

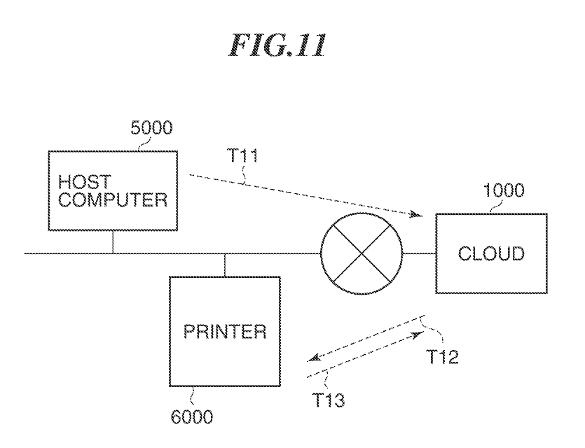

FIG. 11 is a block diagram of a whole printing system including an information processing apparatus according to the second embodiment of the present invention.

In the second embodiment, print job data generated by the host computer 5000 is transmitted to the cloud 1000 (T11 in FIG. 11). The cloud 1000 performs copy-forgery-inhibited pattern processing on the print job data received thereby to generate print data, and sends the print data to the printer 6000 (T12).

If the received print data is data of a print job, the printer 6000 performs printing, whereas if the same is data of a store-in-HDD job, the printer 6000 stores the print data in a storage area, and transmits printing completion notification to the cloud 1000 (T13).

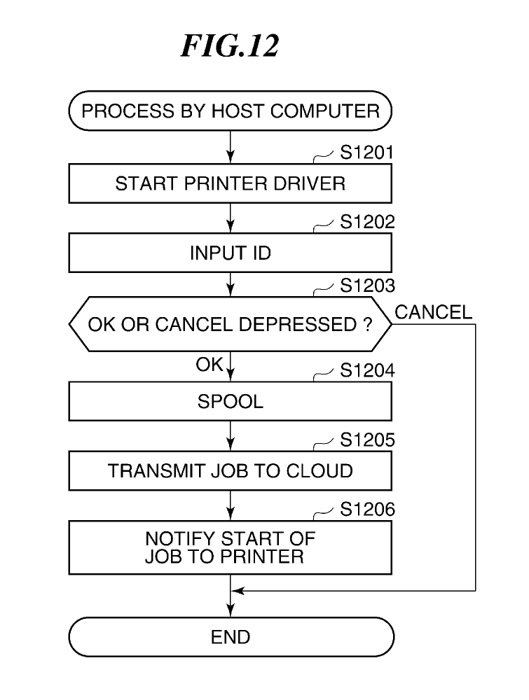

It should be noted that the processing flow in the cloud 1000 is the same as in the first embodiment. Hereafter, different points in the processing by the host computer 5000 and the printer 6000 from those in the first embodiment will be described with reference to FIG. 12.

FIG. 12 is a flowchart of a process executed by the host computer 5000 of the printing system, in the second embodiment.

A step S1201 to a step S1204 are the same as the step S601 to the step S604 in FIG. 5 which are executed by the host computer 5000 in the first embodiment.

In a step S1205 following the step S1204 wherein print job data is generated and spooled, the communication module 5040 transmits print job data to an URL of the cloud 1000 which the communication module 5040 holds, and receives a cloud job ID form the cloud 1000.

In the following step S1206, the communication module 5040 notifies the start of transmission of print job data to the cloud 1000 by job information to the printer 6000. The job information contains a company ID, a user ID, a cloud job ID, etc. The printer 6000 retrieves processed print data from the cloud 1000 using the job information.

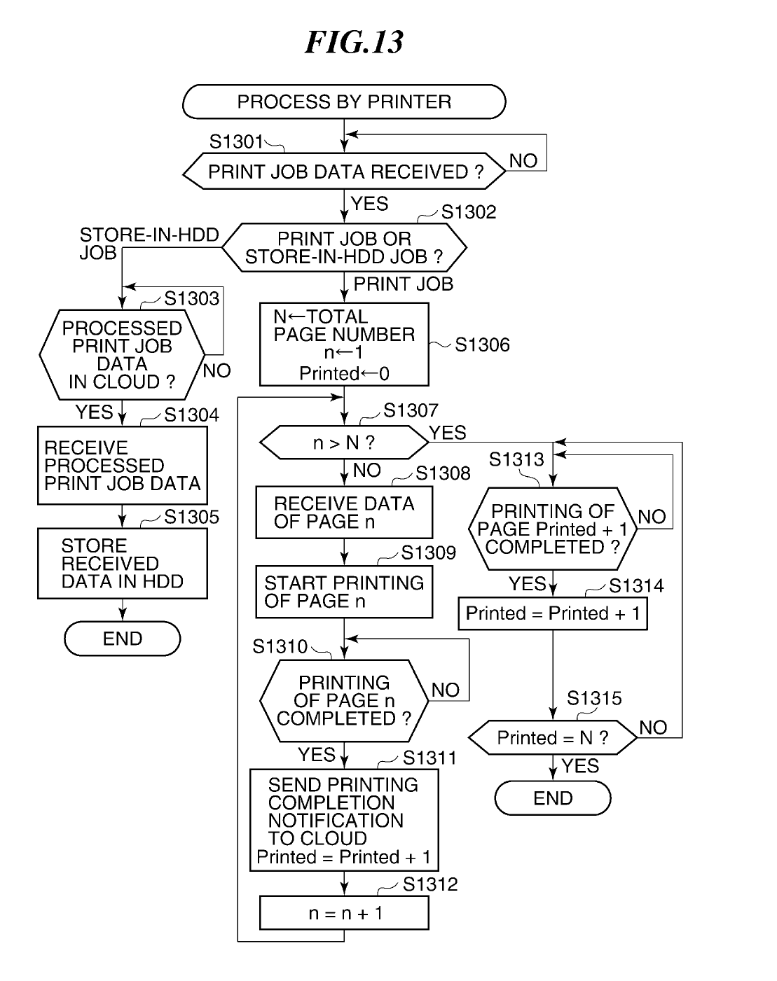

FIG. 13 is a flowchart of a process executed by the printer 6000 of the printing system, in the second embodiment.

The process executed by the printer 6000 in the second embodiment is part of the FIG. 6 process executed by the printer 6000 in the first embodiment from which the steps S702 and S703 are eliminated. That is, steps S1302 to S1315 in FIG. 13 correspond to the steps S704 to S717 in FIG. 6, respectively.

The present embodiment provides the same advantageous effects as provided by the first embodiment.

Next, a third embodiment of the present invention will be described.

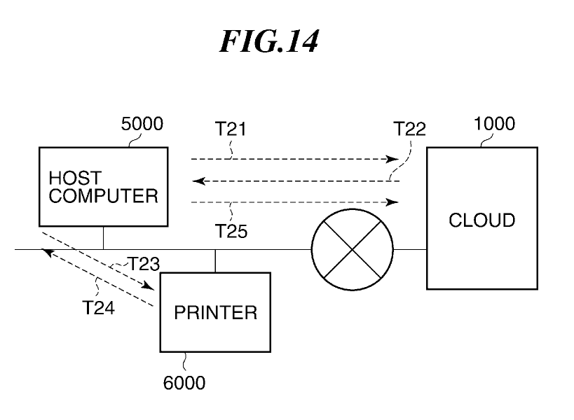

FIG. 14 is a block diagram of a whole printing system including an information processing apparatus according to the third embodiment of the present invention.

In the third embodiment, print job data generated by the host computer 5000 is transmitted to the cloud 1000 (T21 in FIG. 14), and the cloud 1000 performs copy-forgery-inhibited pattern processing on the received job data to generate print data, and transmits the print data to the host computer 5000 (T22).

The host computer 5000 transmits the received print data to the printer 6000 (T23). The printer 6000 performs printing if the received print data is data of a print job, and stores the received print data in a storage area if the same is data of a store-in-HDD job, and then the printer 6000 transmits a printing completion notification to the host computer 5000 (T24). The host computer 5000 having received the printing completion notification transmits a printing completion notification to the cloud 1000 (T25).

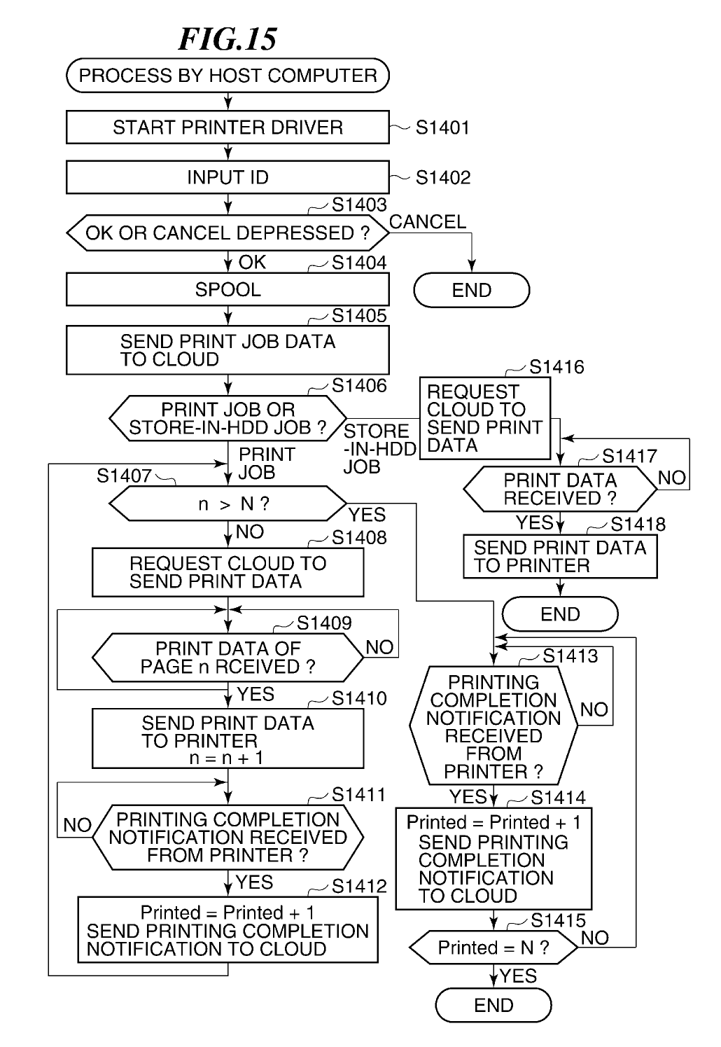

It should be noted that the processing flow by the cloud 1000 is the same as that in the first embodiment. Now, processes executed by the host computer 5000 and the printer 6000 will be described with reference to FIG. 15.

FIG. 15 is a flowchart of a process executed by the host computer 5000 of the printing system, in the third embodiment.

Steps S1401 to S1405 are the same as the steps S1201 to S1205 of the FIG. 12 process executed by the host computer 5000 in the second embodiment. Further, the page number “n” of a page being processed is initialized to 1, and the printing-completed page count “Printed” is initialized to 0. In the step S1405, as soon as the print job data is transmitted to the cloud 1000, the total page number “N” is stored in the work area.

In the following step S1406, it is determined from the job information of the print job data whether or not the print job data is data of a print job or data of a store-in-HDD job. If the print job data is data of a print job, the process proceeds to a step S1407, whereas if the same is of a store-in-HDD job, the process proceeds to a step S1416.

In the step S1407, it is determined whether or not “n” is larger than the total page number “N”, i.e. whether or not there is print data in the cloud 1000. If “n” is larger than the total page number “N”, it is judged that there is no print data in the cloud 1000, and the process proceeds to a step S1413, whereas if “n” is not larger than the total page number “N”, it is judged that there is print data in the cloud 1000, and the process proceeds to a step S1408.

In the step S1408, the host computer 5000 requests the cloud 1000 to send print data of page “n”, and then it is determined in a step S1409 whether or not the print data of page “n” has been received from the cloud 1000. If the print data of page “n” has been received, the process proceeds to a step S1410, wherein the received print data is transmitted to the printer 6000 and the page number n of a page being processed is incremented by 1. Then, in the following step S1411, it is determined whether or not a printing completion notification has been received from the printer 6000. If the printing completion notification has been received, the process proceeds to a step S1412, whereas if not, the step S1411 is repeated. In the step S1412, “Printed” is incremented by 1 and a printing completion notification is transmitted to the cloud 1000.

On the other hand, in the step S1413, it is determined whether or not a printing completion notification has been received from the printer 6000. If the printing completion notification has been received, the process proceeds to a step S1414, whereas if not, the step S1413 is repeated. In the step S1414, “Printed” is incremented by 1 and a print completion notification is transmitted to the cloud 1000. Then, in a step S1415, it is determined whether or not “Printed” is equal to “N”. If “Printed” is equal to “N”, it is judged that all the pages have been printed, so that the present process is terminated, whereas if not, the process returns to the step S1413.

On the other hand, if the print job data is data of a store-in-HDD job, in the step S1416, the host computer 5000 requests the cloud 1000 to send print data, and then it is determined in a step S1417 whether or not the print data has been received from the cloud 1000. If the print data has not been received, the step S1417 is repeated, whereas if the print data has been received, the process proceeds to a step S1418, wherein the received print data is transmitted to the printer 6000, followed by terminating the present process.

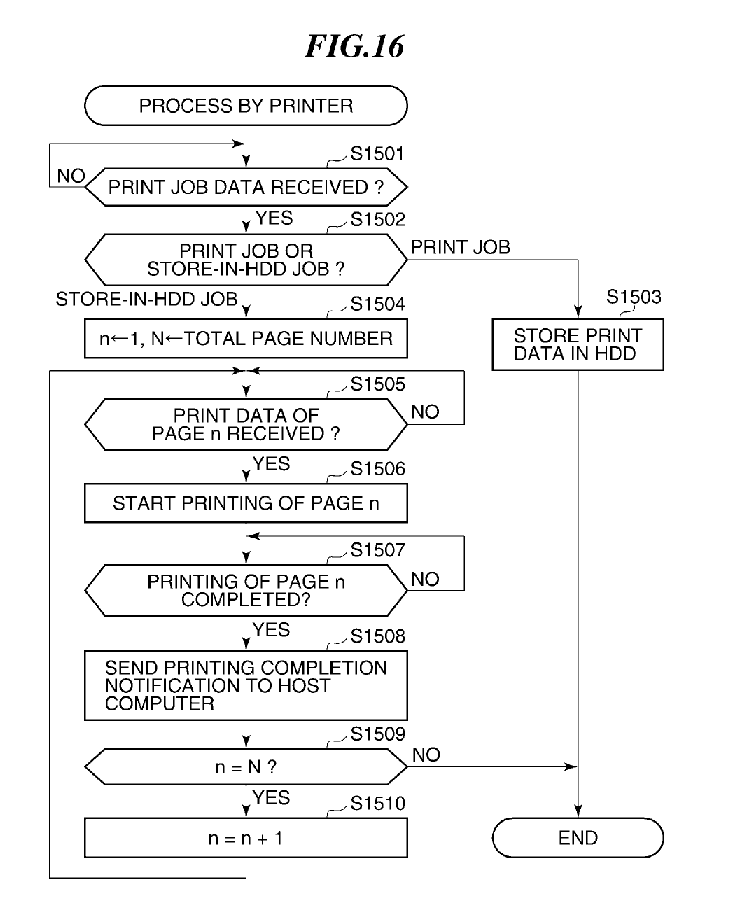

FIG. 16 is a flowchart of a process executed by the printer 6000 of the printing system, in the third embodiment.

In the work area, there are set the page number “n” of a page being processed and the total page number “N”. First, in a step S1501, it is determined whether or not a job is received. If a job is not received, the step S1501 is repeated, whereas if a job is received, the process proceeds to a step S1502, wherein it is determined whether or not the received job is a print job or a store-in-HDD job. If the received job is a store-in-HDD job, the process proceeds to a step S1503, whereas if the same is a print job, the process proceeds to a step S1504.

In the step S1503, the print data is stored in the external memory 314, such as the HDD, which is the storage area of the printer 6000, followed by terminating the present process. On the other hand, in the step S1504, “n” is set to 1, and “N” is set to the total page number of the job information. Then, in a step S1505, it is determined whether or not print data of page “n” has been received from the host computer 5000. If the print data of page “n” has not been received, the step S1505 is repeated, whereas if the print data of page “n” has been received, the process proceeds to a step S1506.

In the step S1506, the print data of page “n” is printed out. Then, it is determined in a step S1507 whether or not the printing of the print data of page “n” has been completed. If it is determined in the step S1507 that the printing of the print data of page “n” has been completed, the process proceeds to a step S1508, wherein a printing completion notification is transmitted to the host computer 5000. Then, it is determined in a step S1509 whether or not the page number “n” of a page being processed is equal to the total page number “N”, i.e. whether or not all the pages have been printed. If “n” is equal to “N”, it is judged that all the pages have been printed, and the present process is terminated, whereas if “n” is not equal to “N” yet, the process proceeds to a step S1510, wherein “n” is incremented by 1, and then the process returns to the step S1505.

The present embodiment also provides the advantageous effects as provided by the first embodiment.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims priority from Japanese Patent Application No. 2009-275448 filed Dec. 3, 2009, which is hereby incorporated by reference herein in its entirety.

What is claimed is:

1. An information processing apparatus that can be connected to an image processing apparatus which receives data via a network and performs image processing on the data, comprising:
a processing unit configured to perform predetermined processing on data received via the network;
a transmission unit configured to transmit processed data which is formed by the predetermined processing of said processing unit, to the image processing apparatus;
a billing unit configured to perform a billing process for billing for the predetermined processing, after a completion notification indicative of completion of the image processing on the processed data transmitted by said transmission unit is received from the image processing apparatus; and
a determination unit configured to determine whether or not the received data is data requiring the completion notification of the image processing,
wherein when the received data is data requiring the completion notification of the image processing, said transmission unit performs transmission of processed data of a next page after receiving a completion notification of the image processing on processed data of a preceding page from the image processing apparatus.

2. The information processing apparatus according to claim 1, further comprising:
a completion notification reception-determining unit configured to be operable when the received data is data requiring the completion notification of the image processing, to determine whether or not the completion notification of the image processing on the processed data of the preceding page has been received; and
an unreceived amount-determining unit configured to be operable when it is determined that the completion notification of the image processing on the processed data of the preceding page has not been received, to determine whether or not a count of pages for which the completion notification of the image processing has not been received is not larger than a predetermined number, and
wherein said processing unit performs processing of a next page, when the count of pages for which the completion notification of the image processing has not been received is not larger than the predetermined number.

3. The information processing apparatus according to claim 1, further comprising:
an acquisition request reception-determining unit configured to be operable when the received data is not data requiring the completion notification of the image processing, to determine whether or not a acquisition request for the processed data which is formed by the predetermined processing of said processing unit has been received via the network, and
wherein when it is determined by said acquisition request reception-determining unit that the acquisition request has been received, said transmission unit transmits the processed data to a requestor, and said billing unit performs the billing process.

4. A method of controlling an information processing apparatus that can be connected to an image processing apparatus which receives data via a network and performs image processing on the data, comprising:
performing predetermined processing on data received via the network;
transmitting processed data which is formed by the predetermined processing, to the image processing apparatus;
performing a billing process for billing for the predetermined processing, after a completion notification indicative of completion of the image processing on the processed data transmitted by said transmitting is received from the image processing apparatus; and
determining whether or not the received data is data requiring the completion notification of the image processing,
wherein when the received data is data requiring the completion notification of the image processing, said transmitting includes transmitting processed data of a next page after receiving a completion notification of the image processing on processed data of a preceding page from the image processing apparatus.

5. A non-transitory computer-readable storage mediums storing a computer-executable program for causing a computer to execute a method of controlling an information processing apparatus that can be connected to an image processing apparatus which receives data via a network and performs image processing on the data,
wherein the method comprises:
performing predetermined processing on data received via the network;
transmitting processed data which is formed by the predetermined processing, to the image processing apparatus;
performing a billing process for billing for the predetermined processing, after a completion notification indicative of completion of the image processing on the processed data transmitted by said transmitting is received from the image processing apparatus; and
determining whether or not the received data is data requiring the completion notification of the image processing,
wherein when the received data is data requiring the completion notification of the image processing, said transmitting includes transmitting processed data of a next page after receiving a completion notification of the image processing on processed data of a preceding page from the image processing apparatus.
